(19) United States
(12) Patent Application Publication
(10) Pub. No.: US 2008/0100534 A1
(43) Pub. Date: May 1, 2008

(54) SWITCH

(75) Inventors: Randy K. Rannow, Albany, OR (US); Zhizhang Chen, Corvallis, OR (US); James W. Stasiak, Lebanon, OR (US); Stanley J. Wang, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/553,261

(22) Filed: Oct. 26, 2006

(51) Int. Cl. G09G 3/20

(52) U.S. Cl. 345/55

(57) ABSTRACT

An imaging apparatus and method include a pixel and a two point switching element.

### CROSS-REFERENCE TO RELATED PATENT APPLICATIONS

The present application is related to co-pending U.S. patent application Ser. No. 11/488,346 filed on Jul. 18, 2006 by Randy K. Rannow, Robert J. Lawton, Thomas Carnis, James W. Stasiak, and entitled FIELD EMITTING DEVICE, the full disclosure of which is hereby incorporated by reference.

### BACKGROUND

Imaging apparatus sometimes include a matrix of pixels. Selectively charging or activating such pixels may involve complex and space consuming circuitry, increasing cost and reducing performance.

### BRIEF DESCRIPTION OF THE DRAWINGS

FIG. 1 is a schematic illustration of an imaging apparatus according to an example embodiment.

FIG. 2 is a circuit diagram of another embodiment of the imaging apparatus of FIG. 1 according to an example embodiment.

FIG. 3 is a fragmentary view schematically illustrating a construct of a pixel cell of the imaging apparatus of FIG. 2 according to an example embodiment.

FIG. 4 is a circuit diagram of another embodiment of the imaging apparatus of FIG. 1 according to an example embodiment.

FIG. 5 is a top plan view schematically illustrating a portion of the imaging apparatus of FIG. 4 according to an example embodiment.

FIG. 6 is a fragmentary perspective view of the imaging apparatus of FIG. 5 according to an example embodiment.

FIG. 7 is a sectional view of the imaging apparatus of FIG. 6 with portions omitted for purposes of illustrating according to an example embodiment.

FIG. 8 is a circuit diagram of an array of pixel cells of the imaging apparatus of FIG. 4 schematically illustrating selective activation of selected cells according to an example embodiment.

FIG. 9 is a circuit diagram of another embodiment of the imaging apparatus of FIG. 1 according to an example embodiment.

FIG. 10 is a schematic illustration of one example of an imaging apparatus including one of the imaging apparatus of FIGS. 1-9 according to an example embodiment.

FIG. 11 is a schematic illustration of another example of an imaging apparatus including one of the imaging appatus of FIGS. 1-9 according to an example embodiment.

### DETAILED DESCRIPTION OF THE EXAMPLE EMBODIMENTS

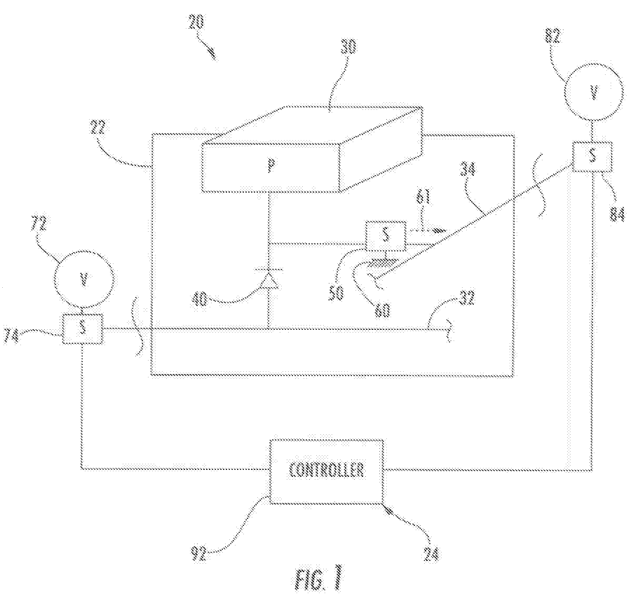

FIG. 1 schematically illustrates imaging apparatus 20. Imaging apparatus 20 comprises an apparatus configured to provide or form an image by selectively activating individual pixel cells 22, one of which is shown. In one embodiment, apparatus 20 is configured to form an image by selectively depositing one or more printing materials upon a print medium. In one embodiment, apparatus 20 may comprise an electrophotographic printing apparatus. One example of an electrophotographic printing apparatus is a device wherein pixel cells 22 are part of a field emitting device and are selectively activated such that electrostatic fields from the field emitting device form a pattern of electrostatically charged areas on a separate imaging surface, wherein printed material, such as toner, is attracted to or are repelled from such areas. Another example of an electrophotographic printing apparatus is a device wherein pixel cells are part of an imaging surface and are selectively activated to form a pattern of electrostatically charged areas on the imaging surface, wherein printing material, such as toner, is attracted to or are repelled from such areas. In still other embodiments, imaging apparatus 20 may be configured as a display, wherein selective activation of pixel cells 22 results in a viewable image being formed. As will be described in detail hereafter, imaging apparatus 20 provides a low-cost and compact arrangement for selectively activating pixel cells 22.

As shown by FIG. 1, imaging apparatus 20 includes a matrix of pixel cells 22, one of which is shown, and off-board or external control electronics 24. Pixel cell 22 includes pixel 30, electrical conductor 32, electrical conductor 34, two point switching element 40 and switching element 50. Pixel 30 comprises an electrically conductive structure having an area configured to be charged such that the area emits an electrostatic field so as to cooperate with electrostatic fields emitted by other pixels 30 of other pixel cells 22 to form a pattern of electrostatic fields. Although pixel 30 is schematically illustrated as a single continuous or uninterrupted electrically conductive area, in other embodiments, pixel 30 may alternatively comprise multiple spaced electrically conductive areas which are part of a single pixel cell 22 and which are charged to a same voltage.

Electrical conductor 32 comprises an electrically conductive line, such as an electrically conductive trace or wire, through which electrical current may be supplied to pixel 30 from control electronics 24 to charge pixel 30. Electrical conductor 32 is electrically connected to control electronics 24 and is electrically connected to pixel 30 of each pixel cell 22. In one embodiment, electrical conductor 32 is one of multiple rows (or columns) of such electrical conductors 32 in electrical connection with each of pixels 30. In the example illustrated, the rows of electrical conductor 32 extend in a layer below a layer containing electrical conductors 34. Electrical conductor 32 cooperates with electrical conductor 34 to address pixels 30.

Electrical conductor 34 comprises an electrically conductive line, such as an electrically conductive trace or wire, through which electrical current may be drained from pixel 30 by control electronics 24. Electrical conductor 32 is electrically connected to control electronics 24 and is electrically connected to pixel 30 of each pixel cell 22. In one embodiment, electrical conductor 34 is one of multiple columns (or rows) of such electrical conductors 34 in electrical connection with each of pixels 30. In the example illustrated, the columns of electrical conductors 34 extend in a layer above the layer containing electrical conductors 32. Electrical conductor 34 cooperates with electrical conductor 32 to address pixels 30.

Two point switching element 40 comprises an element having two points or leads that is configured to switch between a first conductive state and a second distinct conductive state in response to a voltage differential across such points. In the example illustrated, switching element of 40 is further configured so as to be electrically biased in one direction such that element 40 impedes current flow to a greater extent in one direction than another. In the example illustrated, two point switching element 40 permits substantially unimpeded current flow from electrical conductor 32 to pixel 30 up to a predefined voltage while impeding current flow in a reverse direction from pixel 30 to electrical conductor 32. According to one embodiment, two point switching element 40 comprises a diode, such as a p-n junction diode. In other embodiments, element 40 may comprise other two point switching elements such as metal-insulator-metal devices (MIMs) or other diodes.

Two point switching element 40 is generally located within each pixel cell 22 and is part of an active matrix control for pixels 30 of pixel cells 22. Two point switching element 40 facilities the charging of pixels 30 to a predefined voltage level and further assists in sustaining the charge on each of pixels 30 until such charge is drained. Because pixel cells 22 utilize two point switching element 40, rather than a three-point device, such as a transistor, imaging apparatus 20 is less complex in both fabrication and control. In those embodiments in which two point switching element of 40 comprises a diode, each pixel cell may be more compact (potentially providing greater resolution) while substantially maintaining the ability to charge pixel 30 to relatively high voltages which are desired in some applications. In particular, two point switching elements 40 comprising diodes that have the ability to transmit relatively large charges while being relatively small in size as compared to a transistor. In some embodiments, the compact but powerful nature of two point switching element 40 facilitates locating two point switching elements 40 at least partially between the layers of conductors 32 and 34 further enhancing the compactness and size of apparatus 20.

Switching element 50 comprises an element configured to selectively conduct electrical current. Switching element 50 is electrically connected between pixel 30 and electrical conductor 34 so as to selectively conduct electrical current from pixel 30 to selectively drain pixel 30. In the example illustrated, switching element 50 changes between a first electrically conductive state and a second distinct electrically conductive state based the voltage of electrical conductor 34 as set by control electronics 24. In one embodiment, switching element 50 may comprises a three point switching element, such as a transistor, having a source connected to pixel 30, a drain connected to a ground line 60 and a gate connected to electrical conductor 34, wherein electrical conductor 34 conducts a signal current to selectively activate switching element 50 to selectively drain pixel 30. With such an embodiment, switching element 50 may be switched between the different conductive states with a relatively low signal voltage conducted through electrical conductor 34 from control electronics 24.

In another embodiment, switching element 50 may comprise a two point switching element, such as a diode, configured to selectively drain pixel 30 in response to a voltage across the diode. For example, in one embodiment, switching element 50 may comprise a p-n junction diode electrically biased to permit substantially unimpeded current flow from pixel 30 to electrical conductor 34 as indicated by arrow 61 in response to a voltage across switching element 50 exceeding and maintained above a predefined threshold while impeding current flow in a reverse direction from electrical conductor 34 to pixel 30. In such an embodiment, a connection between ground line 60 and switching element 50 may be omitted. Because switching element 50 comprises a diode, the compactness of pixel cell 22 and imaging apparatus 20 may be enhanced as compared to other embodiments in which switching element 50 comprises a transistor.

Control electronics 24 control the selective activation of pixels 30 of pixel cells 22. Control electronics 24 is located off-board, meaning that control electronics 24 are not co-located or intermingled with pixel cells 22, but are off-site or to one side of the array or matrix of pixel cells 22. Control electronics 24 generally includes voltage source 72, switch 74, voltage source 82, switch 84 and controller 92.

Voltage source 72 comprises a source of voltage for charging pixel 30. Switch 74 comprises one or more electrical switching elements configured to selectively conduct charge from voltage source 72 to electrical conductor 32. In one embodiment, switch 74 may comprise one or more transistors. In other embodiments, switch 74 may comprise one or more other electrical switching devices. Switch 74 switches between different conducting states in response to control signals from controller 92.

Voltage source 82 comprises a source of voltage which is used for actuating switching element 50 between the first conductive state and the second conductor state to control draining of charge from pixel 30. Switch 84 comprises one or more electrical switching elements configured to selectively conduct charge from voltage source 82 to electrical conductor 34. In one embodiment, switch 84 may comprises one or more transistors. In other embodiments, switch 84 may comprise one or more other electrical switching devices. Switch 84 switches between different conducting states in response to control signals from controller 92.

Controller 92 comprises one or more processing units configure to generate control signals for controlling switches 74 and 84 to selectively charge and/or drain pixels 30 of pixel cells 22. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 92 may be embodied as part of one or more application-specific integrated circuits (ASICs). Controller 92 is not limited to any specific combination of hardware circuitry and software, nor to any particular source for the instructions executed by the processing unit.

In operation, based upon an image to be formed, either on a print media or on a display, controller 92 generates control signals selectively switching switches 74, 84 to selectively charge and drain pixels 30 to form a pattern (or a negative image or pattern in some embodiments) of charged and discharged pixel cells 22 corresponding to the image. To charge a particular pixel 30, controller 92 generates control signals causing switch 74 to “open” so as to transmit electrical current from voltage source 72 across electrical conductor 32 associated with a particular pixel 30 to be charged. This electrical current is transmitted across two point switching element 40 to pixel 30. At the same time, controller 92 generates control signals actuating switch 84 to a state such that switch and 58 in a “closed” state inhibiting draining of charge from pixel 30. In one embodiment in which switching element 50 comprises a transistor, the voltage supplied across electrical conductor 34 to the gate of switching element 50 is below the threshold value for transmitting electrical current across switching element 50. In other embodiments in which switching element 50 comprises a diode, switch 84 is actuated such that an appropriate electrical current is conducted along electrical conductor 34 such that the voltage across the diode serving as switching element 50 inhibits the flow of electrical current across the diode.

To drain a particular pixel 30, controller 92 generates control signals to actuate switch 74 to a “closed” or disabled state inhibiting the flow of electrical current across the particular electrical conductor 32 associated with the particular pixel 30 being drained. At substantially the same time, controller 92 generates control signals actuating switch 84 to a state such that switching element 50 is in an “open” state permitting draining of charge from pixel 30. In one embodiment in which switching element 50 comprises a transistor, the voltage supplied across electrical conductor 34 to the gate of switching element 50 is at or above the threshold value for substantially transmitting electrical current across switching element 50. In other embodiments in which switching element 50 comprises a diode, switch 84 is actuated such that an appropriate electrical current is conducted along electrical conductor 34 such that the voltage across the diode serving as switching element 50 permits the flow of electrical current across the diode.

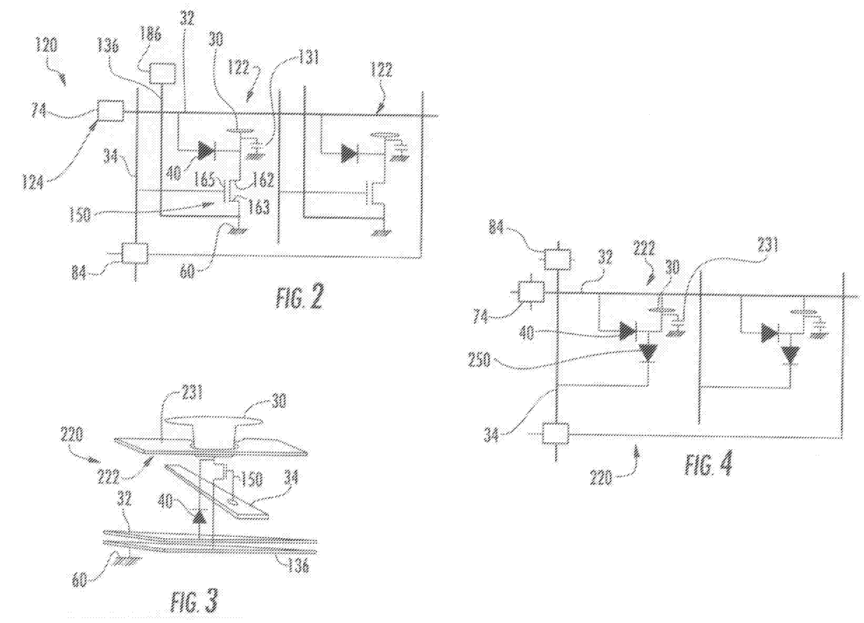

FIGS. 2 and 3 illustrate imaging apparatus 120, another embodiment of imaging apparatus 20. Imaging apparatus 120 includes a matrix or an array of pixel cells 122 and off-board control electronics 124. FIG. 2 is a functional circuit diagram illustrating imaging apparatus 120. In particular, FIG. 2 illustrates a pair of such neighboring pixel cells 122 and control electronics 124. FIG. 3 is a schematic illustration illustrating an example physical construct of one of cells 122.

As shown by FIG. 2, each pixel cell 122 is similar to pixel cell 22 (shown in FIG. 1) except that each pixel cell 122 specifically includes switching element 150 comprising a transistor while additionally including ground or bias plane 131 (schematically represented by a capacitor) and electrical conductor 136. Those remaining elements of pixel cell 122 which correspond to elements of pixel cell 22 are numbered similarly. Switching element 150 includes source 162, drain 163 and gate 165. Source 162 is allegedly connected to pixel 30 or drain 163 is a likely connected to ground 60. 8165 is electrically connected to electrical conductor 34. Like switching element 50, switching element 150 enables charge on pixel 30 to be electively drained to ground 60 based upon signal voltages provided by electrical conductor 34.

Bias plane 131 comprises one or more layers of electrically conductive material extending below a surface of pixel 30 and cooperating with the electrically conductive layer or layers of pixels 30 to function as a capacitor, storing charge. In one embodiment, bias plane 131 may comprise a layer continuously extending across multiple pixel cells 122 below pixels 30. In one embodiment, bias plane 131 additionally serves to shield electrical fields potentially resulting from electrical circuit below pixel 30 from substantially effecting the electrostatic fields of pixel 30.

Electrical conductor 136 comprises an electrically conductive line, such as an electrically conductive trace or wire, through which electrical current may be supplied to drain 163 of switching element 150 by control electronics 24. Electrical conductor 136 is electrically connected to control electronics 24 and is electrically connected to drain 163 of each pixel cell 22. Electrical conductor 136 enables charge to be drained from pixel 30 such that the voltage of pixel 30 may be controlled and set at a level between the lower ground or rail voltage as set by ground 60 and the charging voltage as determined by a charge conducted by electrical conductor 32 and further conducted by two point switching element 40. In other embodiments, electrical conductor 136 may be omitted.

Control electronics 124 is substantially similar to control electronics 24 except that control electronics 124 additionally includes switch 86 connected to a voltage source (not shown). Switch 86 comprises one or more switches configured to selectively control the electrical charge conducted by electrical conductor 136 to drain 163 to establish or set the voltage to which pixel 30 is drained upon actuation of switching element 150 to an electrically conductive state. In one embodiment, switch 86 may comprise an application-specific integrated circuit (ASIC). In other embodiments, switch 86 may comprise other power or charge control devices. In those embodiments in which electrical conductor 136 is omitted, switch 186 may also be omitted.

As shown by FIG. 3, pixel 30 is generally located above the layers providing electrical conductors 32, 34 and 136 (sometimes referred to as “metal layers”) and extend through an opening in bias plane 31. In the particular example illustrated, switching element 150 is located between electrical conductor 34 and pixel 30 while two point switching element 40 is formed and located between the layers providing electrical conductors 32 and 34. In particular, switching element 40 is located between an upper surface of electrical conductor 34 and a lower surface of electrical conductor 32. Because element 40 comprises a two point switching element, switching element 40 is more compact (potentially increasing image resolution) and may be more easily fabricated between such layers. In those embodiments in which switching element 40 is a diode, switching element 40 is configured to conduct relatively large charges while maintaining a relatively compact size.

According to one example embodiment, two point switching element 40 comprises a diode which conducts electrical current up to a voltage of approximately −200 V is established across element 40 switching element 150 comprises a transistor configured to be enabled in response to a signal voltage of approximately 28 V at gate 165. In other embodiments, switching elements 40 and 150 may have other operating characteristics.

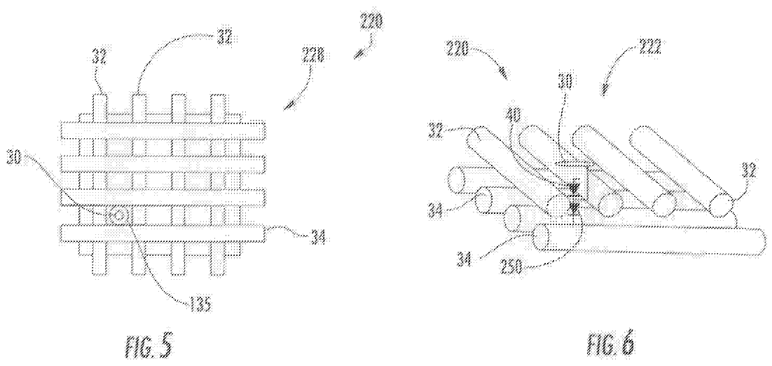

FIGS. 4-7 illustrate imaging apparatus 220, another embodiment of imaging apparatus 20. Imaging apparatus 220 includes a matrix or an array of pixel cells 222 and off-board control electronics 224. FIG. 4 is a functional circuit diagram illustrating imaging apparatus 220. In particular, FIG. 4 illustrates a pair of such neighboring pixel cells 222 and control electronics 224.

As shown by FIG. 4, each pixel cell 222 is similar to pixel cell 22 (shown in FIG. 1) except that each pixel cell 222 specifically includes switching element 250 comprising a diode while additionally including ground or bias plane 231 (schematically represented by a capacitor). Those remaining elements of pixel cell 122 which correspond to elements of pixel cell 22 are numbered similarly. Because switching element 250 comprises a diode, the compactness of pixel cell 222 and imaging apparatus 220 may be enhanced as compared to other embodiments in which switching element 250 comprises a transistor.

Bias plane 231 comprises one or more layers of electrically conductive material extending below a surface of pixel 30 and cooperating with the electrically conductive layer or layers of pixels 30 to function as a capacitor, storing charge. In one embodiment, bias plane 231 may comprise a layer continues the extending across multiple pixel cells 222 below pixels 30. In one embodiment, bias plane 231 additionally serves to shield electrical fields potentially resulting from electrical circuitry below pixel 30 from substantially effecting the electrostatic fields of pixel 30.

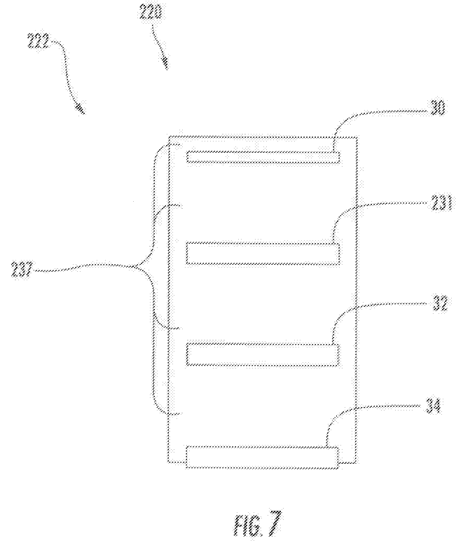

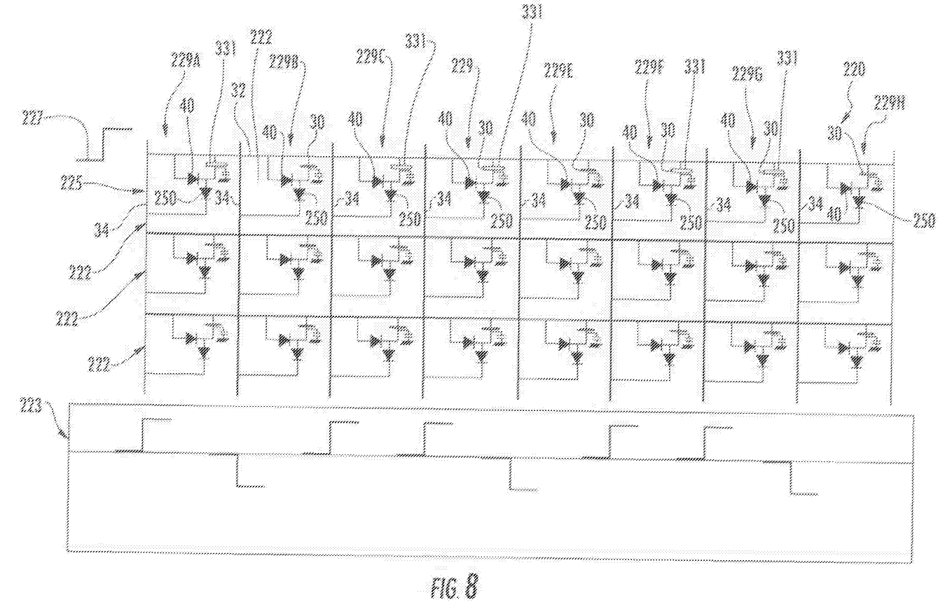

FIGS. 5-7 are schematic illustrations illustrating an example of one of cells 222. FIG. 5 is a top view of an example of one of pixel cells 122. For ease of illustration, FIG. 5 and FIG. 6 omit bias layers or planes 231. FIG. 7 is a sectional view of one of cells 222. For ease of illustration, FIG. 7 omits switching elements 40 and 250.

As shown by FIG. 5, pixel 30 is located between pairs of neighboring electrical conductors 34 and between pairs of neighboring electrical conductors 32. In one embodiment, each space 135 between consecutive electrical conductors 32 and consecutive electrical conductors 34 (as viewed from the top as seen in FIG. 5) is beneath or coextensive with a pixel 30 of a pixel cell 222. As shown by FIGS. 6 and 7, pixel 30 is generally located above the layers providing electrical conductors 32, 34 and 136 (sometimes referred to as “metal layers”).

As further shown by FIG. 6, switching elements 40 and 250 are formed and located between the layers providing electrical conductors 32 and 34. In particular, switching elements 40 and 250 are located between an upper surface of electrical conductor 32 and a lower surface of electrical conductors 34. As shown by FIG. 7, the layers providing electrical conductors 32 and 34 as well as the layers providing bias plane 231 and pixel 30 are separated from one another by one or more layers 237 of dielectric material to form the architecture of pixel cells 222. Because elements 40 and 250 comprise two point switching elements, such switching elements are more compact and may be more easily fabricated between such layers. In those embodiments in which switching elements 40 and 250 each comprise a diode, switching elements of 40 and 250 are configured to conduct relatively large charges while maintaining a relatively compact size.

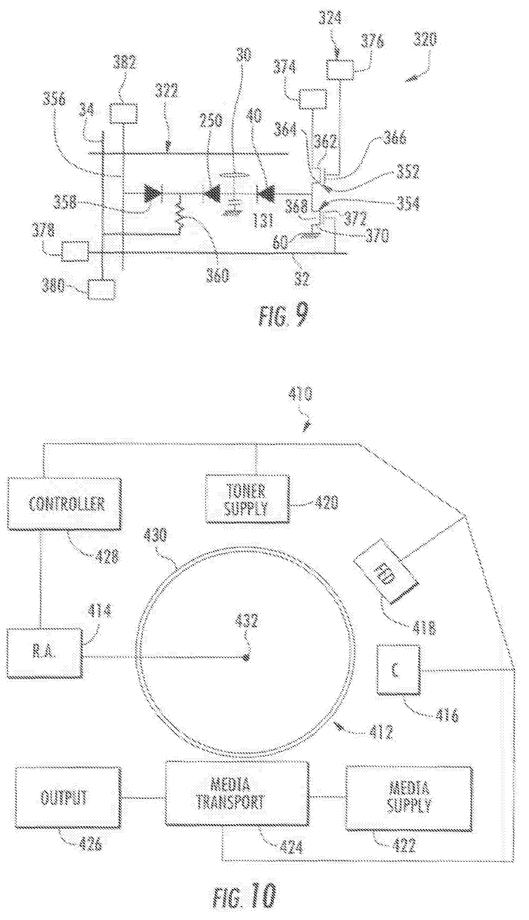

FIG. 8 is a circuit diagram of multiple pixel cells 222 illustrating operating of imaging apparatus 220 in response to control signals 223 from control electronics 124 (shown in FIG. 4). FIG. 8 illustrates selective activation of pixel cells 222 which are arranged in a row 225. Based upon an image to be formed, either on a print media or on a display, controller 92 (shown in FIG. 1) generates control signals selectively switching switches 74, 84 (shown in FIG. 4) to selectively charge and drain pixels 30 to form a pattern (or a negative image or pattern in some embodiments) of charged and discharged pixel cells 222 corresponding to the image. In the example operation scenario depicted by FIG. 8, switch 74 (shown in FIG. 4) associated with row 225 is enabled by controller 92 as indicated by square waveform 227. As a result, charge from voltage source 72 (shown in FIG. 1) is conducted by electrical conductor 32 and across switching elements 40 of each of pixel cells 222 of row 225. At the same time, controller 92 (shown in FIG. 1) generates control signals enabling or activating switches 84 associated with rows 229A, 229C, 229D, 229F and 229G such that charge is transmitted across electrical conductors 34 to establish a voltage across switching elements 250 of those pixels cells 222 in rows 229A, 229C, 229D, 229F and 229G that is less then a predetermined threshold for such switching elements 250 such that charge is not conducted across such switching elements 250, allowing charge upon each of such associated pixels 30 to be built up to a desired level as schematically indicated by boxes 331. At the same time, switches 84 (shown in FIG. 4) remained disabled such that the voltage across switching elements 250 of pixel cells 220 in columns 229B, 229E and 229H is greater than a predetermined threshold of such elements 250 such that any charge conducted to such pixels 30 by elements 40 is drained. In a similar manner, other rows 225 and columns 229 of pixel cells 220 may be selectively activated based upon control signals from controller 92 (shown in FIG. 1).

According to one example embodiment, switching element of 40 comprises a diode configured to conduct current up to voltage of approximately −150 V across element 40. Switching element 250 comprises a diode configured to conduct electrical current in response to a voltage existing across element 150 that is greater than or equal to about 10 V. In other embodiments, switching elements 40 and 250 may have other operating characteristics.

FIG. 9 is a circuit diagram of imaging apparatus 320, another embodiment of imaging apparatus 20. In particular, FIG. 9 illustrates a single pixel cell 322 and associated control electronics 324. Pixel cell 322 is similar to pixel cell 222 except that pixel cell 322 additionally includes switching elements 352, 354, electrical conductor 356, switching element 358 and current limiter 360. Switching elements 352 and 354 cooperate to control charge being conducted to pixel 30 across switching elements 40. In the example illustrated, the switching elements 352 and 354 comprise transistors. Switching element 352 includes a source 362 electrically connected to a voltage source provided by control electronics 324, a drain 364 electrically connected to pixel 30 and a gate 366 electrically connected to control electronics 324. Switching elements 354 includes a source 368 electrically connected to pixel 30 and electrically connected to drain 364, a drain 370 electrically connected to ground 60 and a gate 372 electrically connected to electrical conductor 32. Switching elements 352 and 354 enable pixel 30 to be charged to greater positive and negative voltages. In some applications, such as those applications in which print material or toner is applied to a media, this feature may be employed to clean toner from a toner carrying surface. In other embodiments, switching elements 352 and 354 may comprise other switching elements or may be omitted.

Electrical conductor 356 comprises an electrically conductive line, such as an electrically conductive trace or wire extending from control electronics 324 to switching element 358. In the example illustrated, switching element 358 comprises a diode substantially similar to switching elements 250 but biased in an opposite direction towards pixel 30. Current limiter 360 comprises a resistor electrically connected between switching elements 250 and 358 and extending into connection with electrical conductor 34. Electrical conductor 356, switching element 358 and current limiter 360 cooperate to establish a voltage across switching element 250 that may be different from a rail voltage provided by electrical conductor 34. Similar to electrical conductor 136 of imaging apparatus 120, electrical conductor 356, switching on 358 and current limiter 360 enables charge to be drained from pixel 30 such that the voltage of pixel 30 may be controlled and set at a level between the lower ground or rail voltage as set by electrical conductor 34 and the charging voltage as determined by a charge conducted by electrical conductor 32 and further conducted by two point switching element 40.

Control electronics 324 selectively activate each of pixel cells 322 of imaging apparatus 320. Control electronics 324 are substantially located off-board from the array of pixel cells 322 of imaging apparatus 320. Control electronics 324 includes switches 374, 376, 378, 380 and 382. Switch 374 comprises one more switching elements configured to supply a relatively large charge or voltage from a voltage source (not shown to source 362 of switching element 352. Switch 376 comprises one or more switching elements configured to selectively apply voltage from a voltage source (not shown) to gate 366. Switch 378 comprises one or more switching elements configured to selectively supply voltage from a voltage source to gate 372 of switching element 354. Switches 374, 376 and 37 eight cooperate to selectively control charge being supplied to switching element of 40 and to pixel 30. In particular embodiments, appropriate voltage that is may be applied to get 372 through conductor 32 to enhance draining of charge from pixel 30 to ground 60 for a larger range of charges that may be established for pixel 30.

Switch 380 comprises one or more switching elements configured to selectively apply charge from a voltage source (not shown) to switching element 250 across current limiter 360 and electrical conductor 34. Switch 382 comprises one or more switching elements configured to selectively apply charge from a voltage source (not shown) to switching element 250 across switching element 358 and electrical conductor 356. Switches 380 and 382 cooperate to selectively establish a voltage the cross switching element 250 to control draining of charge from pixel 30 to a predetermined level of charge.

In operation, based upon control signals from controller 92 (shown in FIG. 1), switches 374, 376 and 378 are selectively activated depending upon the desired charge to be applied to pixel 30. For example, pixel 30 may be charged by controller 92 enabling switching on switching element 352 and disabling switching element 354. Pixel 30 may be charged to other voltages by selectively enabling switching element 354. In particular embodiments, controller 92 may disable switching element 352 and may enable switching element 354 with a relatively large voltage applied to gate 372 such that charge may be drained from pixel 30 to ground 60, increasing a range of charge levels at which pixel 30 may be set.

At the same time, based upon control signals from controller 92, switches 380 and 382 are selectively activated or enabled. For example, switch 380 may be enabled and charge may be conducted via electrical conductor 34 such that pixel 30 may be drained to the voltage provided by electrical conductor 34. Alternatively, pixel 30 may be drained to intermediate voltages by controller 92 (shown in FIG. 1) enabling switch 382 to conductor an electrical charge across electrical conductor 356 and across switching element 358 to establish a different voltage level across switching element 250. Overall, imaging apparatus 320 provides greater imaging versatility by facilitating the display or printing at different grayscale levels. Moreover, pixel cells 322 provide imaging apparatus 320 with the ability to apply relatively large positive and negative charge polarities to pixel 30.

According to one example embodiments, switching element 40 comprises a diode configured to conduct electrical current up to a voltage level across switching element 40 of about −110 V. Switching elements 250 and 358 comprised diodes configured to conduct electrical current in response to a voltage level across such elements at or above about 60 V. Switching elements 352 and 354 comprise transistors configured to conduct current in response to signal voltages applied at gates 366 and 372.

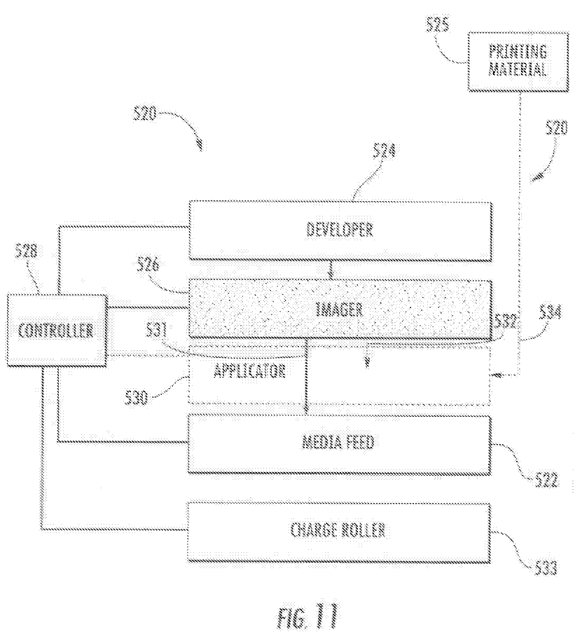

FIG. 10 illustrates one example of an image forming apparatus 410 in which any of imaging apparatus 20, 120, 220 and 320 shown in FIGS. 1-9 may be employed. Image forming apparatus 410 is configured to print or otherwise form images upon media using toner or other print material and an electrostatically charged surface. Image forming apparatus 410 generally includes drum 412, Rotary actuator 414, cleaner 416, field emitting device 418, toner supply 420, media supply 422, media transport 424, output 426 and controller 428.

Drum 412 comprises a cylindrical member having an electrically conductive surface 430. Drum 412 is configured to be rotated about an axis 432 so as to move electrically conductive surface 430 relative to cleaner 416, field emitting device 418, toner supply 420 and media transport 424. In one embodiment, electrically conductive surface 430 may be formed from a metal such as copper, aluminum, or any of conductive/semi conductive materials. In other embodiments, electrically conductive surface 430 may be formed from other electrically conductive metals or may be formed from other of electrically conductive materials. In still other embodiments, in lieu of an electrically conductive surface 430 being provided by drum 412, electrically conductive surface 430 may alternatively be provided by other structures movably supporting electrically conductive surface 430. For example, in other embodiments, electrically conductive surface 430 may be provided by a belt which is movably supported by two or more rollers.

Rotary actuator 414 comprises a device or mechanism configured to move electrically conductive surface 430. In the particular example illustrated, rotary actuator 414 is configured to rotate drum 412 about axis 432. In those embodiments in which electrically conductive surface 430 is provided by other structures, rotary actuator 14 may have other configurations or may be omitted. Rotary actuator 414 is operably coupled to drum 412 by a drive train such as a gear train, chain and sprocket arrangement, belt and pulley arrangement and the like.

Cleaner 416 comprises one or more devices or mechanisms configured to prepared electrically conductive surface 430 for receiving charge from field emitting device 418 and for receiving toner from toner supply 420. In one embodiment, cleaner 416 comprises a device configured to discharge electrostatic forces along electrically conductive surface 430. For example, in one embodiment, cleaner 416 may comprise a Corona discharge device. In other embodiments, cleaner 416 may have other configurations for removing or discharging electrostatic charge from electrically conductive surface 430.

In particular embodiments, cleaner 416 may additionally be configured to remove any remaining toner or other printing material from surface 430. For example, in some embodiments, cleaner 416 may additionally include a device configured to scrape, brush or otherwise remove toner or other printing material from electrically conductive surface 430. In other embodiments, cleaner 416 may alternatively omit such toner removing components.

Field emitting device 418 comprises a device configured to selectively apply electrostatic charge to portions of electrically conductive surface 430 so as to form an electrostatic image on electrically conductive surface 430. In the particular example illustrated, field emitting device 18 is supported substantially stationary as electrically conductive surface 430 is moved relative to field emitting device 418. As a result, field emitting device 418 has few or no moving parts and may have less complex circuitry and electrical interconnects, reducing cost.

Field emitting device 418 includes one of imaging apparatus 20, 120, 220 or 320 as described above. Selective charging of pixels 30 (shown in FIGS. 1-9) of field emitting device 418 creates a pattern of electrostatic fields which form a pattern of charged areas upon surface 430. As a result, toner from toner supply 420 is selectively attracted or repelled from such charged areas of the surface of 430 and subsequently forms a pattern upon media carried a media transport 424.

Toner supply 420 comprises a presently developed or future developed device configured to supply one or more colors of toner to electrically conductive surface 430. In one embodiment, toner supply 420 may be configured to supply power or particulate toner. In other embodiments, toner supply 420 may be configured to supply liquid toner. In one particular embodiment, toner supply 420 supplies positively charged toner. In other embodiments, toner supply 420 alternatively supplies a negatively charged toner. Due in part to the charge of the toner supply by supply 420, the toner is selectively attracted to or repelled from portions of electrically conductive surface 430 based upon electrostatic fields along surface 430 as provided by field emitting device 418.

Media supply 422 comprises a presently developed or future developed device configured to input media to be printed into apparatus 410. In one embodiment, media supply 422 may also serve to store media until the media is printed upon. In one embodiment, media supply 422 may comprise one or more feed or input trays or bins.

Media transport 424 comprises a device configured to transport or move media from media supply 422 relative to drum 412 and to output 426. In one embodiment, media transport 424 comprises a series of rollers configured to frictionally engage the media so as to transport the media. In yet other embodiments, media transport 424 may comprise belts or combination of belts and rollers configured to move media.

Output 426 comprises a device or structure configured to receive printed upon media. In one embodiment, output 426 provides persons with access to the printed upon media, enabling the finished printed upon media to be removed from apparatus 410. In such an embodiment, output 426 may comprise an output tray or bin. In other embodiments, output 426 may comprise a pathway or entrance to yet another apparatus for further processing or handling of the printed upon media. For example, in other embodiments, output 426 may comprise an input for a duplexer, stapler or other media processing or manipulating device.

Controller 428 comprises a processing unit configured to generate control signals directing rotary actuator 414 to rotate drum 412, directing cleaner 416 to clean electrically conductive surface 430, directing field emitting device 418 to selectively charge electrically conductive surface 430, directing toner supply 420 to supply toner to an electrically conductive surface 430 and directing media transport 424 to move media relative to drum 12. Controller 428 includes controller 92 or replaces controller 92 (shown in FIGS. 1-9).

In operation, controller 428 generates control signals directing field emitting device 418 to selectively charge electrically conductive surface 430 of drum 412 as rotary actuator 414 drives drum 412 about axis 432. Controller 428 further generates control signals directing toner supply 420 to present toner to electrically conductive surface 430. Because surface 430 is electrostatically charged, the toner which is itself charged, will be attracted to or repelled from selected portions of drum 412. The toner is subsequently transferred to media provided by media transport 414. In one embodiment, the toner is attracted to the media by a device (not shown) having an opposite electrostatic charge on an opposite side of the media. In particular embodiments, the toner is the additionally fused to the media with a fuser (not shown) prior to being discharged to output 426. Once delivered to output 416 by media transport 424, the printed upon media may be removed from apparatus 410 or may be transferred to additional apparatus for further processing or manipulation. Because field emitting device 418 is substantially stationary and because electrically conductive surface 430 is moved relative to field emitting device 418, the construction of field emitting device 418 may be less complex with fewer pixels, fewer switching devices and less intricate electrical circuitry, reducing cost.

FIG. 11 schematically illustrates image forming apparatus 520, another example of an imaging system in which any of imaging apparatus 20, 120, 220 or 320 shown in FIGS. 1-9 may be employed. Image forming apparatus 20 is configured to form or print an image upon a medium, such as paper. Image forming apparatus 520 generally includes media feed 522, developer 524, imager 526 and controller 528. Media feed 522 comprises a device or mechanism configured to transfer and position media to be printed upon. Examples of media include sheets of paper, rolls of paper, transparencies, and other cellulose and non-cellulose based materials upon which an image or pattern of one or more materials are to be formed. In one embodiment, media feed 522 may include one or more rollers, belts and the like driven by a motor or other power source. In still other embodiments, media feed 522 may be omitted where a medium is manually positioned relative to the remaining components of image forming apparatus 20.

Developer 524 comprises a device configured to be electrically charged so as to function as a counter-electrode to the electrodes provided by imager 526, wherein developer 524 and imager 526 form a capacitor providing electrostatic fields between developer 524 and imager 526. In the particular embodiment illustrated, developer 524 is also configured to supply one or more printing materials to be deposed upon media based upon the electrostatic fields. In one embodiment, developer 524 provides a supply of electrostatically charged printing material, facilitating selective deposition or transfer of the printing material to the media. In one embodiment, developer 524 supplies electrostatically charged toner. In other embodiments, developer 524 may be configured to supply other electrostatically charged printing materials. In one embodiment, developer 524 comprises a magnetic brush type developer. In other embodiments, developer 524 may comprise other development architectures such as contact developers, jump gap developers and the like.

Imager 526 comprises a device configured to cooperate with developer 524 to provide a pattern or image of varying electrostatic fields across a surface of imager 526. Imager 526 includes a surface including a two-dimensional array of pixels 30, such as provided by imaging apparatus 20, 120, 220 and 320 shown in FIGS. 1-9, configured to have a voltage applied thereto and to be charged so as to cooperate with developer 524 to form differing electrostatic fields across the surface of imager 526. Based upon the voltage differential between each individual pixel 30 and developer 524, the printing material, supplied by developer 524, is electrostatically attracted to or repelled from individual pixels 30, on or below the surface of image 526, based on the electrostatic field at each pixel 30. As a result, circuitry for charging such individual pixels may be more compact, may provide imager 256 with greater resolution, and may be less expensive.

In one embodiment, imager 526 may constitute a drum or roller having a surface including such pixels. In another embodiment, imager 526 may constitute a belt having a surface including such pixels. The drum or belt of imager 526 may be driven by a motor or other torque source (not shown).

Controller 528 comprises a processing unit configured to generate control signals directing the selective charging (or discharging) of the pixels of imager 526 to form the pattern or image upon the surface of imager 526 or to form a portion of the final pattern to be developed upon the surface of imager 526. In the particular embodiment illustrated, controller 528 generates control signals directing the operation of media feed 522, developer 524 and imager 526. In other embodiments, controller 528 may generate control signals directing the operation of imager 526 alone. Controller 528 includes controller 92 or replaces controller 92 (shown in FIGS. 1-9).

In operation, controller 528 generates control signals selectively charging or discharging the pixels along the surface of imager 526 in the desired pattern. Controller 528 further generates control signals directing a voltage source (not shown) to appropriately charge developer 524 such that electrostatic fields are created between developer 524 and imager 526. Based upon the pattern of electrostatic fields formed along the surface of the imager 526, printing material, such as toner, supplied by developer 524 transfers to the surface of imager 526. In one embodiment, the printing material provided by developer 524 is electrostatically charged. Based upon the electrostatic field between developer 524 and the individual pixels on the surface of imager 526, the printing material is selectively attracted or repelled from portions of imager 526. For example, in one embodiment, the toner or other printing material may have a positive polarity or charge. In such an embodiment, voltage source 72 (shown in FIG. 1) for one of apparatus 20, 120, 220 or 320 (shown in FIGS. 1-9) may be configured to provide a voltage having a positive polarity, wherein the printing material will be attracted to the more negatively charged areas. In another embodiment, the toner or other printing material may have a negative polarity or charge. In such an embodiment, voltage source 72 may be configured to provide a voltage having a negative polarity, wherein the printing material will be attached to the more positively charged areas. For example, developer 524 may be charged to a first negative voltage (i.e. −300 V) while a particular pixel is charged to a second lesser negative voltage (i.e. −50 V) with the printing material comprising toner having a negative charger. In such an instance, because the toner is negatively charged, the toner is attracted to a more positive charge, i.e. the pixel. In yet another instance, the developer may be charged to a first negative voltage while a particular pixel is charged to a second greater negative voltage such that negatively charged toner is repelled from the particular pixel. In forming the image of printing material upon imager 526, controller 528 may generate control signals to vary the voltage differential between developer 524 and imager 526 to vary the strength of the electrostatic field and to vary the degree to which a printing material or toner is attracted to or repelled from individual pixels. In such a manner, the darkness of the image developed on the pixel may be controlled, as well as the print quality attributes.

Once the printing material has been selectively deposited and retained along the surface of imager 526, controller 528 generates control signals directing media feed 522 to move or transport a medium relative to imager 526. At the same time, controller 528 generates control signals directing imager 526 to rotate or move relative to the medium such that the printing material is deposited and applied to the medium carried by media feed 522 as indicated by arrow 531. In one embodiment, image forming apparatus 520 may additionally include a charge roller 533 on an opposite side of the media being printed upon to imager 526. In such an embodiment, the charge roller 533 is charged to a more positive or less negative voltage as compared to the charge of pixels 30 (shown in FIGS. 1-9) of imager 526 to transfer the negatively charged printing material or toner to the media being moved between imager 526 and the charge roller 533 by media feed 522. In other embodiments, the charge polarity may be reversed. In other embodiments, charge roller 533 may be omitted.

As shown in phantom, in another embodiment, image forming apparatus 520 may additionally include an applicator 530. In lieu of printing material upon the surface of imager 526 being directly transferred to media carried by media feed 522, applicator 530 is utilized to transfer such printing material to media carried by media feed 522. For example, in one embodiment, applicator 530 may constitute an intermediate belt or drum having a surface upon which the printing material is transferred from imager 526 in the desired pattern or image as indicated by arrow 532, wherein applicator 530 is itself driven by a motor or other power source not shown in response to control signals from controller 528 to further transfer the printing material to the medium carried by media feed 522.

In still another embodiment, applicator 530 may constitute a drum or belt having an electrically non-conductive surface, wherein the pixels along the surface of imager 526 are charged and are moved relative to the electrically non-conductive surface of applicator 530 so as to selectively charge distinct portions of the surface of applicator 530 to distinct electrostatic charges. As indicated by arrow 534, in such an alternative embodiment, printing material may be supplied to applicator 530 rather than to imager 526 by an alternative source 525 of printing material other than developer 524. Based upon the pattern of differently charged portions created by imager 526 along the surface of applicator 530, the printing material is attracted or repelled from selected portions of applicator 530. Thereafter, the printing material is directly transferred from applicator 530 to media carried by media feed 522. In such an embodiment, imager 526 may constitute a stationary structure or bar including a plurality of rows of pixels (such as pixels 30 of FIGS. 1-9) that are selectively charged or discharged, wherein applicator 530 is rotated or otherwise moved relative to the stationary imager 526.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with referent to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a first electrically conductive pixel; and
a first two point switching element electrically connected to the pixel.

2. The apparatus of claim 1, wherein the first two point switching element comprises a diode.

3. The apparatus of claim 1 further comprising:
a first voltage source electrically coupled to a first side of the first two point switching element;
a second switching element electrically coupled to the pixel and configured to drain charge from the pixel; and
a second voltage source electrically connected to the second switching element to selectively actuate the second switching element.

4. The apparatus of claim 3, wherein the second switching element comprises a transistor.

5. The apparatus of claim 4, wherein the second voltage source is connected to a gate of the transistor and wherein the apparatus further comprises a third voltage source electrically connected between the second switching element and ground.

6. The apparatus of claim 3, wherein the second switching element comprises a first diode.

7. The apparatus of claim 3, wherein the first switching element comprises a first diode biased in a first direction towards the pixel, wherein the second switching element comprises a second diode biased in the first direction away from the pixel and wherein the apparatus further comprises:
a third voltage source; and
a third diode electrically connected to the third voltage source and biased in a second opposite direction towards the pixel.

8. The apparatus of claim 6 further comprising a resistor electrically connected between the second diode and the third diode and electrically connected to the second voltage source.

9. The apparatus of claim 8 further comprising:
a first transistor having a source electrically connected to the first voltage source, a first drain election the connected to the first diode and a gate electrically connected to a fourth voltage source; and
a second transistor having a second source electrically connected to the first drain, a second train electrically connected to ground and a gate electrically connected to a fifth voltage source.

10. The apparatus of claim 1 further comprising an array of pixel cells, each cell including the first electrically conductive pixel and the first two point switching element.

11. The apparatus of claim 10, wherein each pixel cell additionally includes a second switching element electrically coupled to the pixel and configured to selectively drain charge from the pixel and wherein the apparatus further comprises:
a first voltage source electrically coupled to a first side of the first two point switching element of each pixel cell, the pixel electrically coupled to a second side of the first two point switching element of each pixel cell;
a second voltage source electrically coupled to the second switching element of each pixel cell to selectively actuate the second switching element of each pixel cell;
rows of first electrical conductors, each of the first electrical conductors electrically connected to the first voltage source and the first two point switching element of each pixel cell; and
columns of second electrical conductors, each of the second electrical conductors connected to the second voltage source and the second switching element.

12. The apparatus of claim 11, wherein the one of the first electrical conductors and the second electrical conductors have an upper surface, wherein the other of the first electrical conductors and the second electrical conductors extend below said one of the first electrical conductors and the second electrical conductors and have a lower surface and wherein the first two point switching elements are contained between the upper surface and the lower surface.

13. The apparatus of claim 12, wherein the second switching elements are contained between the upper surface and the lower surface.

14. The apparatus of claim 13, wherein the second switching elements comprise two point switching elements.

15. The apparatus of claim 14, wherein the second switching elements comprise diodes.

16. The apparatus of claim 11, wherein the first switching element is contained between consecutive first electrical conductors and consecutive second electrical conductors.

17. The apparatus of claim 16, wherein the second switching element is contained between the consecutive first electrical conductors and between the consecutive second electrical conductors.

18. The apparatus of claim 1, wherein the pixel is part of an electrophotographic printing device.

19. An apparatus comprising:
means for selectively charging and discharging an electrically conductive pixel of a pixel cell with at least one two point switching element.

20. A method comprising:
selectively charging an electrically conductive pixel of a pixel cell by transmitting electrical current across a two point switching element within the pixel cell.
